(19) United States
(12) Patent Application Publication
(10) Pub. No.: US 2018/0066490 A1
(43) Pub. Date: Mar. 8, 2018

(54) METHOD AND SYSTEM FOR TRANSMITTING SIGNALS FROM A DISTRIBUTED ACOUSTIC SENSOR THROUGH A ONE PIN SOLUTION OF A SUBSEA WELLHEAD

(71) Applicant: Read AS, Hvalstad (NO)

(72) Inventor: Tore KJOS, Oslo (NO)

(73) Assignee: Read AS, Hvalstad (NO)

(21) Appl. No.: 15/553,830

(22) PCT Filed: Jan. 14, 2016
(86) PCT No.: PCT/EP2016/050597

§ 371 Date: Aug. 25, 2017

(30) Foreign Application Priority Data
Feb. 27, 2015 (NO) 20150273

(51) Int. Cl. E21B 33/035; E21B 47/12; G01V 1/22; G01V 1/52

(52) U.S. Cl. CPC E21B 33/035; G01V 1/52; G01V 1/226; E21B 47/123

(57) ABSTRACT

A method and system for transmitting signals from a distributed acoustic sensor, DAS, into a well through at least one pin penetrator running from a downhole side to a top side of a subsea wellhead, and without degrading quality of the signals. The method includes: connecting a first assistant recording package, ARP, between the DAS and the at least one pin penetrator on a downhole side of the wellhead; connecting a second ARP between a data acquisition system and the at least one pin penetrator on the topside of the well head; converting DAS signals to electrical signals by the first ARP and performing signal conditioning; transmitting signals received from the DAS sensors, from the first ARP and through the wellhead to the second ARP. The system implements the method.

### INTRODUCTION

The present invention is within the field of signal transmission in subsea installations. More specifically the invention comprises a method and system for transmitting signals from optical sensors downhole through at least one pin penetrator running from downhole side to topside of a subsea wellhead, and doing so without degrading the quality of the signals.

### BACKGROUND

Passing seismic signals through a wellhead will normally require a two-way communication. In a subsea wellhead only a one pin solution for electrical signals is normally available. This is a limiting factor for transmission of signals between a recording unit on the topside of the wellhead and sensors downhole. This can be solved with different transmission functions built into the subsea installation for replacing surface equipment on a platform.

If seismic data is acquired with a Distributed Acoustic Sensor (DAS) a continuous unbroken fibre connection is required. This does however present a problem if fibre optic signals are to be passed through a wellhead having only a one pin solution for transferring signals to a receiver located on the topside of the wellhead. Functions for reading fibre optic signals will be required in the well by means of equipment located below the wellhead.

In order to be able to pass signals from a DAS through a wellhead, a conversion of optical signals to electrical signals is required. This conversion has to be performed downhole below the wellhead. The current intensity that can be passed through a pin connection on a wellhead is limited. A voltage splitter may thus be required downhole.

The present invention suggests installing said functions in an Assistant Recording Package (ARP) placed below the wellhead between tubing and housing in an environment close to the seabed with a favourable temperature condition for electronic components. Signals that is lost or degraded when running through a wellhead casing have to be repaired with functions on each side of the wellhead. The present invention presents a solution for this.

According to the invention, two way communications between downhole sensors and a surface recording system is replaced by communication between functions in the ARP and the sensor and a clock downhole. This will replace the requirement to bring the signals up and down through a wellhead. The functions provided below the wellhead will also reduce the noise signals created between a wellhead and a control room on a platform and deliver more accurate and higher quality of seismic signals acquired with sensors in the well. The ARP below the wellhead is attached to the tubing. A thermal isolation between tubing and the ARP is securing a temperature almost the same as the seabed, providing a favourable temperature condition for electronic components. Many functions implemented on sensors downhole in an environment with high temperatures can be replaced with functions implemented in the ARP placed below the wellhead. The dimensions of the ARP are minimal and are limited in the way it is installed between casing and tubing just below the wellhead for securing the safest transmission of electrical data and the shortest way through the wellhead.

An ARP with receiver/transmitter functionality on each side of the wellhead has to be established in the subsea environment. This can be an ARP located on an umbilical or on a subsea station. The mechanical design of an ARP is then in the form of a cylindrical sensor house built to withstand high pressures.

A seismic array installation in a well, oil or gas reservoir may have several important functions for micro seismic monitoring of seismic events. 4D VSP (Vertical Seismic Profile) can be provided by reshooting of 3D VSP with time lapse for the purposes of following fluid front movements, monitoring vibrations along an ideal swinging tubing for monitoring in- and outflow of a well, monitoring mechanical conditions of a well, monitoring leakages in a well and leakages in a reservoir. Other sensors as pressure, temperature, sonic or magnetic sensors can be connected to the seismic array.

The present invention can in one embodiment be a part of such a seismic array. A description of possible functions of the seismic array will be described.

Micro seismic monitoring in a well requires an array of geophones spaced apart for monitoring seismic events in a reservoir. By using 3-dimensional geophones arranged in an array that is clamped to the casing or wellbore, it is be possible to detect the small earthquakes made by the fluid fronts moving in the reservoir by oil drainage and water injection. To be in a position for acquiring micro seismic events, noise signals have to be extracted. Noise signals do however also comprise important vibration data related to operating data and the condition of the well elements.

For obtaining high quality of the micro seismic data it is therefore important that vibration data is correctly extracted, transferred and interpreted.

Up to today transferring of the micro seismic signals through a wellhead has not been possible. The present invention makes this possible by improving and repairing signals on both sides of the wellhead.

The present invention describes a new method and system for acquiring seismic signals by using fibre cables that are extended in a wellbore. Fibre optic cables extended in a wellbore are described in patent application GB 2492802A by Statoil. The application describes acquisition of acoustic signals travelling along a well and where these are acquired by the fibre optic distributed acoustic sensor (DAS) comprised in the fibre optical cable. This requires a continuous unbroken fibre from a sender to a receiver and back. It is however not possible to pass fibre optic signals through a subsea wellhead even if this has fibre optical penetrators.

With the present invention it will however be possible to pass signals from fibre optic cables that are extended in a wellbore, and also so with far improved signals. Most DAS acquired noise signals are received after a wellhead, i.e. between the wellhead and the recording unit. A method for repairing signal passing through a fibre optic connector is to have a processing loop for removing blockage of the signals.

3D VSP can be acquired with a permanent seismic array in the well and a source array provided by boat moving in spiral circles around the well or a number of lines above the reservoir. If this permanent installation is done in a subsea well, a rig can move to a new well and a survey can be acquired by use of ROV and an umbilical down to the subsea wellhead with a flat pack in the end of the umbilical to connect to the permanent seismic array at the wellhead. The 3D VSP can be done without expensive rig costs involved. A large 3D VSP can last up to 20 days with conventional VSP technology where the rig cost alone may cost up to 20 mill USD. In such a case the entire installation cost for the permanent seismic array is earned back only on saved rig costs.

Re-shooting with time lapse of 3D VSP after a production has started can follow the fluid front in the reservoir and optimize the production. Subsea wells are giving lower recovery rates. Information from 4D VSP and micro seismic can avoid channelling and coning with higher recovery rates as a result. The major energy consumption in the declining oil production period is the energy for water injection. A higher oil production will also give less CO2 consumption per barrel of oil and are also an improvement argument in the climate debate.

Detecting and measuring vibration in a swinging pipe is a well known method for determining fluid transport in a pipe and the mechanical condition of the pipe. Tubing hanging in a well with gliding anchoring is almost an ideal swinging pipe. Measurements of the vibration satellites are receiving along this swinging pipe, as noise signals to the seismic signals, can be interpreted and important data of fluid in/out flow, zone, gas, oil, water, sand ratios can be indicated. Vibration data acquired in this way is mostly through secondary vibrations through mechanical coupling between tubing (inner pipe) and casing (outer pipe). The long array of satellites along the casing in one end of the piping can detect events in the other end of the piping. This means that no satellites are required in the in/out flow zone.

Micro seismic is small earthquakes caused by fluid flow in the reservoir. An injection well will spread out the water as a front towards the producing wells. Information about the small earthquakes can be acquired and processed to see how the fluid front is working between two 3D VSP surveys. Micro seismic can detect coning and channels in the reservoir. Micro seismic can also detect leakages in a reservoir.

All these data are important data for enhancing oil recovery and avoiding oil or gas leakage disasters in a reservoir. Micro seismic received from an array in a water injection well has a lot of advantages. The small earthquakes created by the waterfront are clearer and has the shortest distance to the sensors in the water injector in a reservoir. Channels can be detected at an early stage and thus be avoided. The temperature in a water injector is almost ideal for electronics and is securing lifetime operation of the seismic array. The possibility to stop the injection if correctly planned during 3D VSP acquisition without stopping oil production is a factor providing high cost savings and provides a large advantage for the quality of the 3D VSP. The noise signals created by the flow in the tubing are more predictable and easier to extract. The space between the tubing and the casing is also much more favourable. The illuminating area and the possibility to use multiple migrations to increase the coverage area are of advantage and will also saving costs.

When water is pressed into a reservoir with a water injector, a pressure build-up is creating a geological changed condition in reservoir giving seismic signals reflecting this. In a 3D VSP these reflections are detected and by shooting 3D VSP with time lapse it is possible to see how this pressure build-up front have moved in the reservoir, giving 4D VSP.

Another advantage micro seismic from a water injector has, is the possibility to stop the water injector and watch the micro seismic reverse pressure build down. This is similar to a well test with reverse pressure built down or built up in a reservoir where the velocity of the declining/increasing pressure can give information of the size of the reservoir. In a similar way the small earthquakes decreasing the pressure will give information on how this pressure front is built up. The seismic events activity will be larger were a severe equal pressure front is built up and less in a channel where all water is disappeared without any oil recovery function.

The most economical installation of such a seismic array is in a subsea water injector. The improved oil recovery can be earned back more safely and in a shorter time than any other installation. It is extremely expensive to go into a well with an expensive rig in order to get similar logging information as the seismic array according to the invention can provide. Avoiding one such intervention with information provided by the seismic array instead of logging will pay back the whole investment.

### Short Description of the Invention

The present invention is set forth and characterized in the main claims.

In particular, the present invention is described by a method for transmitting signals from a distributed acoustic sensor, DAS, running downhole into a well through at least one pin penetrator running from downhole side to topside of a subsea wellhead, and doing so without degrading the quality of the signals. The method is characterised in:
connecting a first assistant recording package, ARP, between said DAS and said at least one pin penetrator on the downhole side of the wellhead;
connecting a second ARP between a data acquisition system and said at least one pin penetrator on the topside of the wellhead;
by means of said first ARP:
   acquiring DAS signals from the DAS by means of an interrogator unit in the first ARP;
   converting optical signals to electrical signals by means of a converter in said first ARP;
   adjusting voltage amplification to required levels by means of a signal splitter and signal conditioning means in said first ARP;
   transmitting processed DAS signals through the at least one pin penetrator by means of a transmitter in said first ARP, and
by means of said second ARP:
   receiving signals, transmitted through the at least one pin penetrator by said first ARP, by means of a receiver in the second ARP

Further features of the method are defined in the claims.

The invention is also defined by a system for transmitting signals from a distributed acoustic sensor, DAS, running downhole into a well through at least one pin penetrator running from downhole side to topside of a subsea wellhead, and doing so without degrading the quality of the signals. The system comprises:
a first assistant recording package, ARP, that is connected between said DAS and said at least one pin penetrator on the downhole side of the wellhead, said first ARP comprises:
   an interrogator unit for enabling acquirement of DAS signals, from the DAS;
   a converter in said first ARP for converting optical signals to electrical signals;
   a signal splitter and signal conditioning means for adjusting voltage amplification to required levels;
   a transmitter in said first ARP for transmitting signals from said DAS;
   a second assistant recording package, ARP, that is connected between a data acquisition system and said at least one pin penetrator on the topside of the wellhead, said second ARP comprises:
   a receiver for receiving signals through the wellhead from the first ARP.

Further features of the system are defined in the claims.

### DETAILED DESCRIPTION OF THE INVENTION

The invention will now be described in detail with reference to the drawings where:

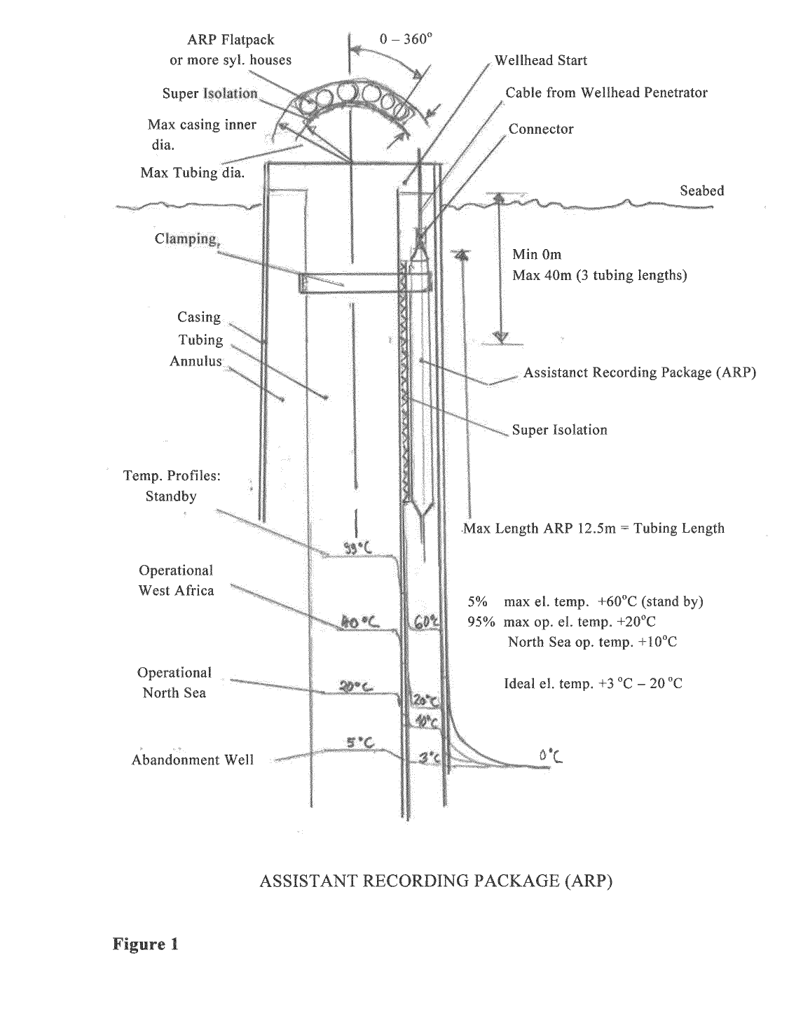

FIG. 1 illustrates an assistant recording package (ARP) placed in the annulus between the casing and tubing;

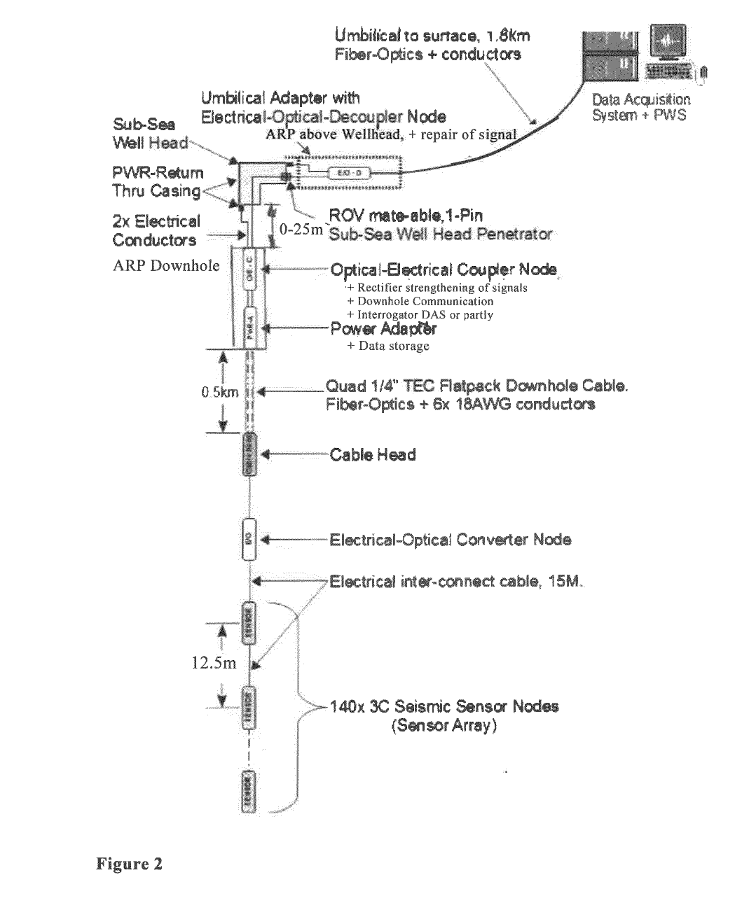

FIG. 2 illustrates a complete system according to the invention;

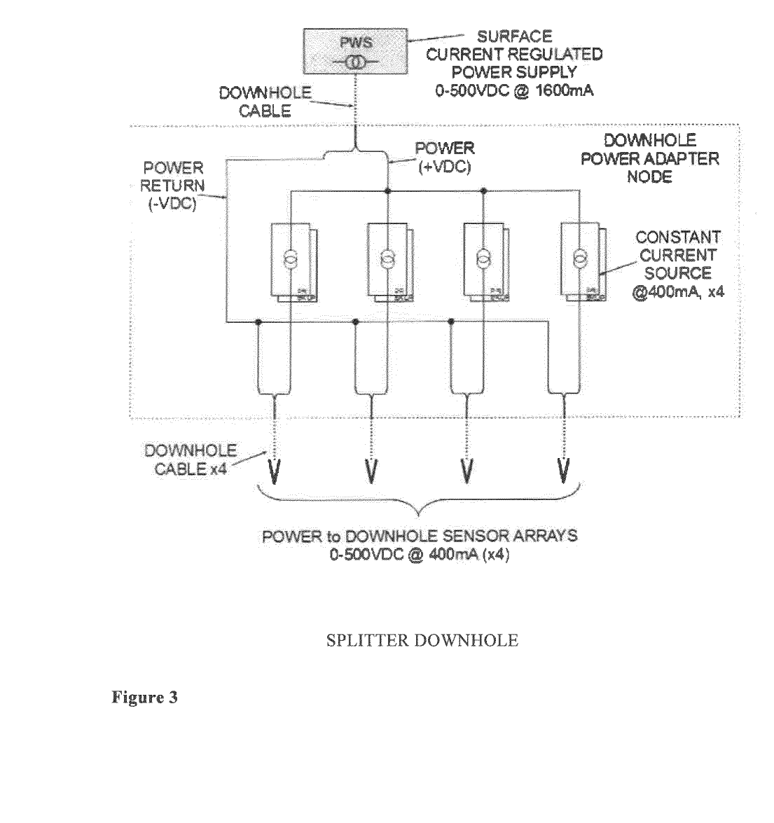

FIG. 3 illustrates a downhole splitter;

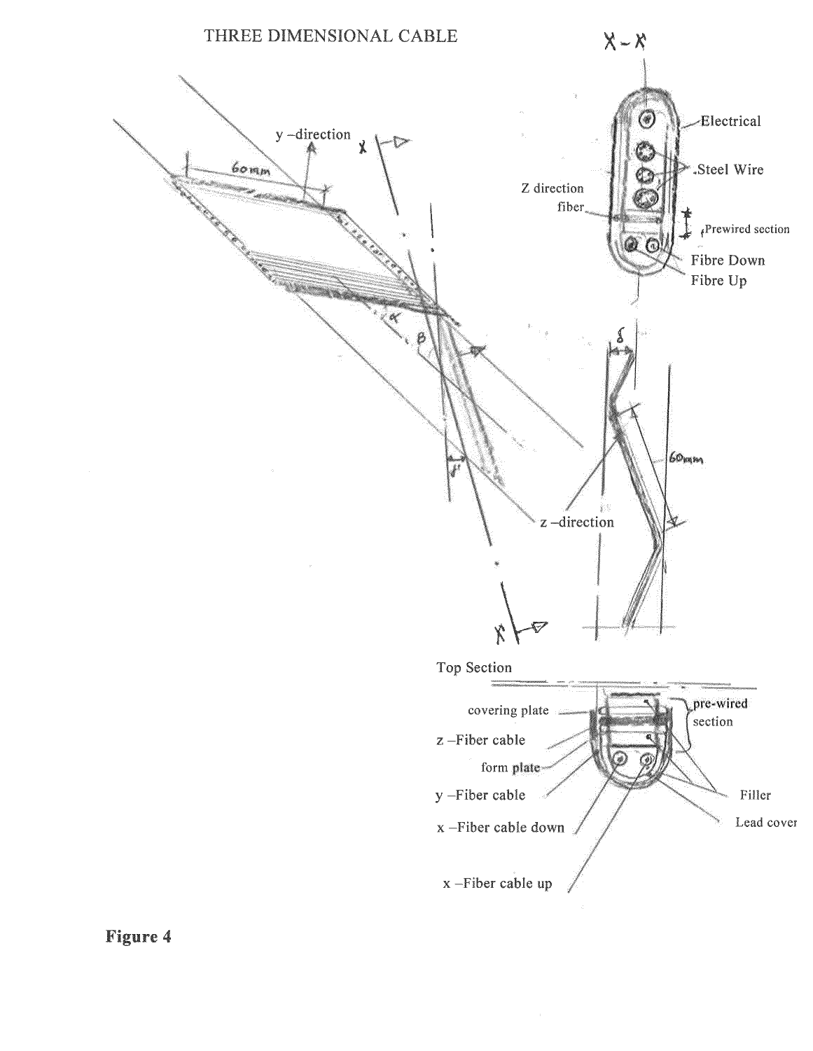

FIG. 4 illustrates a three dimensional cable, and

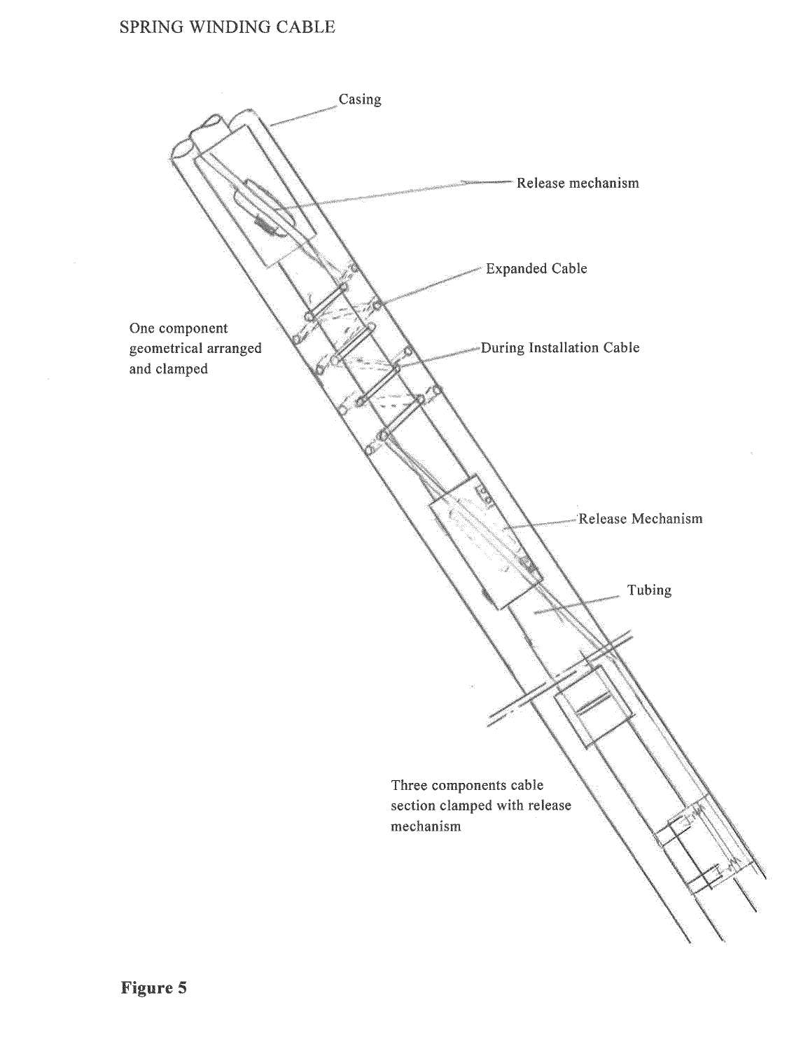

FIG. 5 illustrates a spring winding cable.

The present invention solves the problem of passing seismic signals through a subsea wellhead. It has been tried to let ultrasonic signals pass through a wellhead without using a cable but the transmission signal rate is too low. Fibre optical penetrators have been developed but the reliability of such, especially under installation has been very poor. Due to constructional features of a wellhead it is only possible to install a limited number of penetrators. Using several penetrators will also increase the risk for expensive failures during a subsea operation. Using several penetrators in a subsea well for passing seismic signal through the wellhead is thus no solution.

The invention solves said problem by providing a method and system for transmitting signals from a distributed acoustic sensor, DAS, running downhole into a well through at least one pin penetrator running from a downhole side to topside of a subsea wellhead, and doing so without degrading the quality of the signals.

The method comprises several steps. The first step is connecting a first assistant recording package, ARP, between said DAS and said at least one pin penetrator on the downhole side of the wellhead.

In one embodiment of the invention, the first said ARP is placed 0 to 40 meters below the wellhead. This will provide an ideal environment for electronic components lifetime operation and signal quality.

It has been found that the location where an ARP is placed is very important. Work on the present invention started about 7 years ago, when the inventor started the work with a permanent seismic array in a well for improving oil recovery in a subsea field. It was known knowledge in the field that a limited amount of seismic signals could be transferred via electrical cables over longer distances. Through practical tests it was discovered that electric created seismic signals could pass through a one pin wellhead in a short distance with an electric cable. However, the test well for the installation of the first seismic installation was changed from a subsea wellhead to a platform dry wellhead. The remaining part of the first development was a downhole clock. The industry was back then however of the opinion that communication with the recording unit on the topside was so important that a system with a downhole clock was not the correct solution for a permanent seismic array. At the same time sensors and electronic equipment can be made more simplified and critical temperature components can be moved from sensors in high temperature regions to the ARP located in ideal temperature conditions. By placing an ARP just below the wellhead, an ideal environment for electronic components is provided as well as lifetime signal quality.

The second step of the present invention is connecting a second assistant recording package, ARP, between a data acquisition system and said at least one pin penetrator on the topside of the wellhead.

The wellhead casing is preferably used as a signal path and a common earthing point for said first and second ARP.

The first or second ARP or both are preferably provided with signal conditioning means for making signals clearer and stronger.

The next steps are performed by means of the first ARP. These are: acquiring DAS signals from the DAS by means of an interrogator unit in the first ARP, and converting these optical signals to electrical signals by means of a converter in said first ARP. The voltage amplification is adjusted to required levels by means of a signal splitter and signal conditioning means in said first ARP. The converted and processed DAS signals are then transmitted through the at least one pin penetrator in the wellhead by means of a transmitter in said first ARP.

The last step of the present invention is receiving the signals transmitted through the at least one pin penetrator by means of a receiver in the second ARP.

In one embodiment of the invention DAS signals are transmitted from the second ARP to a data acquisition and processing system by means of a transmitter in the second ARP. This can for instance be located on a vessel, and the signals are transmitted via an umbilical.

The system according to the present invention comprises a first ARP that is connected between electrical and/or optical sensors and at least one pin penetrator on the downhole side of a wellhead.

FIG. 1 illustrates the ARP placed in the annulus between the casing and tubing. In this embodiment, the ARP is isolated from the tubing with super isolation. Circulating water in the annulus will further provide cooling for the electronic components comprised in the ARP. The water will be cooled down via the steel casing and the surrounding sea water at the seabed (0° C.).

The operating environment for the electronic components is almost ideal, from a temperature point of view as well as a noise signal point of view. The temperature will typically be between plus 5-25° C. in averagely 95% of the operational life. The remaining 5% of the lifetime the temperature bay increase due to heat up of reservoir gas or oil during shut down, but it will normally be limited to approximately 60° C. The maximum temperature can only be between reservoir temperature, maximum 99° C. in the annulus and the minimum temperature at the seabed, 0° C. Having a solution according to the embodiment shown in FIG. 1, the maximum temperature will be estimated to 60° C.

The size of the case or housing of the ARP shown in FIG. 1 must be limited. It is only maximum 80 mm space between the casing and tubing available and the length of such a sensor package is limited to the tubing length with the same diameter, i.e. approximately 12.5 m. The shape of the ARP house must therefore be either cylindrical or have a shape as a bowed flat pack around the tubing or many cylinders around the tubing. The outer diameter must be less than inner diameter of the casing, and the inner diameter greater than the outer diameter of the tubing. The connecting two sides must have a diameter that is less than the free opening between the tubing and the casing.

All required functionality for collecting and processing signals from downhole sensors are provided in the ARP located in a safe environment just below the wellhead.

FIG. 2 illustrates one embodiment of the invention, showing the first ARP located downhole and which is connected to the downhole side of a subsea wellhead. The specific embodiment shows a combined fibre optic and electric seismic sensor cable adapted for measuring vibrations.

The combined fibre optic and electric seismic sensor cable may comprise a string with a plurality of levels of geophones (seismic sensor nodes) and an electrical to optical converter node connected to a cable head which in turn is connected to the lower end of a DAS.

The housing of the first ARP is preferably placed close to the wellhead, i.e. maximum 40 meters from the downhole side of the wellhead. Signals from the ARP are passed through the wellhead with a coax electrical cable with the core connected to a one pin penetrator in the wellhead and with the shield connected to the casing of the wellhead. Wellheads can be equipped with one or two pin system for passing signals. A one pin system will give all functionality required according to the present invention, but a two pin system will provide better signal quality.

It is a fact that direct signals from sensors are critical to noise prior to being digitized. Special fibre optical signals through a wellhead penetrator and further up to the topside recording unit will be exposed to noise created by unknown vibrations in cables and other unknown noise signals above wellhead. Such sources of noise are difficult to locate and remove. Seismic noise below a wellhead is normally noise that can be extracted from a signal. According to one aspect of the present invention, seismic noise is removed before transferring sensor signals through the wellhead.

According to one embodiment of the invention, DAS signals from a permanent seismic sensor array is transferred to the first ARP by means of an interrogator or part of an interrogator build into the ARP. This will eliminate several unwanted problem factors like seismic noise, heat, transmission of fibre optic seismic signal through a subsea wellhead. It is also vital that the electrical signal path through the wellhead is as short as possible. A maximum distance of 25 meters is found to be within an acceptable range. The ARP provides the possibility of using simpler sensors that are less critical with regards to temperature. Several functions of complex sensors located downhole can be moved to the ARP.

The inventive ARP can be build with more functions, such as signal rectifiers to make the signals clearer and stronger before being passed through a wellhead. It may also include an electrical splitter.

FIG. 3 illustrates an electrical splitter used for avoiding too high voltages being passed through a penetrator in a wellhead and connected cables. The ARP may typically further comprise a converter unit for converting signals from fibre optical signals to electrical signals and vice versa.

A communicator unit can be installed between the sensors and the clock and an interrogator or part of the interrogator to be able to acquire DAS signals through a wellhead for acquiring distributed acoustic sensor signals from fibre optic cables running from the first ARP and into the well.

All electronic units implemented in the first and second ARP can be backed up with automatic or semiautomatic build in replacements unit for increasing reliability and providing redundancy. The invention does however not require all said functions in one node at the same time but inclusion according to required functions is necessary.

The second ARP is built in on the other side of the wellhead, i.e. the topside including means for repairing damaged or weak signals, means for converting electrical signals back to fibre optical signals and other possible functionality for transmitting safe seismic signals from wellhead to a recording unit over long distances.

A subsea wellhead may comprise a connector for connecting a ROV (Remote Operated Vehicle) or a floating buoy via an umbilical. The rig or vessel can then move before a larger 3D VSP operation is executed. Rig cost savings in this earlier move is enough to pay off the installation cost of the permanent seismic array according to the present invention.

A ROV operated from a boat makes the system independent of a recording unit on a platform or FPSO (Floating Production, Storage and Offloading). The VSP operation or micro seismic operation can therefore start earlier and with a more economical boat solution than expensive rig costs. The whole drilling program can be performed faster. The result from the 3D VSP operation from the boat can give information to the drilling of the next well with the same rig as installed in the seismic array. The boat operated micro seismic can also give information about the drilling bit position.

An umbilical connected to a wellhead can be operated on a boat with a cable drum unit similar to a wireline unit. The boat operating the ROV with the umbilical must preferably have a ROV an opening in the boat for operating a ROV in and out of the vessel and for operating the umbilical.

The umbilical must have a combined electrical sensor cable for instrument power and fibre optical cables for transmitting the seismic signals acquired in the well. The recording unit on the boat is used for receiving the seismic signals. The umbilical may require heave compensation.

FIG. 4 shows an example of a three dimensional cable. The interrogator unit in the ARP may acquire DAS signals along a fibre cable with two separate cables connected at the end leading signals down in one cable and up in another cable.

This acquisition is only taking up 1-component seismic signals. It is the measured length influence created by the fibre optical cable components behaviour from seismic events and the fast acquisition of this length increase (caused by the seismic event) down to every meter event along the cable that are providing the DAS seismic profile. If the fibre cables have an angle to each other, ref. FIG. 4, the cable influence from seismic events will give different lengths. Measuring this difference will give a second direction. Turning the cable again 90 degrees will give another direction with an angle to the first one. Three dimensional seismic can then be acquired with DAS. The differential angle α and β will give two directions due to different length measurement from the same seismic event. As an example when a is 90 degree and β is as low as possible, assumed 30°, two vectored components has occurred. The third component is the straight fibre in x direction.

The three dimensional cable shown in FIG. 4 has xyz directional fibre cables. The x-directional fibre cable is a straight forward fibre cable along the main cable axis, one leading down, twinned connection at the bottom, and one leading up. A DAS acquisition on this part is giving a true x direction.

The y fibre cable is winded with an angle α to the cable length axis. The length of the straight part is approximately 60 mm and must be winded with a certain strength to optimize the signal quality. The angle α is varied between 15° and 90°.

The z fibre is made in a pre-winded section. A form plate of polyamide or equivalent is forming curves and straight lines (e.g. 60 mm) for acquiring a z component.

As an alternative to the z component it is possible to counter wind a differential y with a β angle to the cable length axis. The variation of beta is between 15° and 90° to the cable length axis. The difference of y will give an indication of a z component.

FIG. 5 illustrates a spring winding cable. Having the cable winded and expanded around the tubing by turning the sensor clamping in 90° to each other a different length can be achieved in certain sections. This will give indications of direction of the seismic events. The three dimensional cable can be clamped to casing wall with release mechanism and springs.

If the signals can not be transferred due to limited capacity, data storage of signals can be build into the ARP unit. This data storage can be storage for storing signals for a complete survey, or only parts of a survey. The data from the storage can then be sent to a topside recording unit when the capacity is available.

The umbilical connected to an ARP subsea can also be connected to a floating buoy. This will make it possible to use only one boat combined source and recording vessel with or without ROV for a survey, and having all survey data stored.

1-14. (canceled)

15. A system for transmitting signals from a distributed acoustic sensor, DAS, running downhole into a well through at least one pin penetrator running from a downhole side to topside of a subsea wellhead, the system comprising:
a first assistant recording package, ARP, that is connected between the DAS and the at least one pin penetrator on the downhole side of the wellhead, the first ARP comprises:
an interrogator unit for enabling acquirement of DAS signals, from the DAS;
a converter for converting optical signals to electrical signals;
a signal splitter and signal conditioning means for adjusting voltage amplification to required levels;
a transmitter for transmitting signals from the DAS;
a second assistant recording package, ARP, that is connected between a data acquisition system and the at least one pin penetrator on the topside of the wellhead, the second ARP comprises:
a receiver for receiving signals from the first ARP through the wellhead;
means for repairing damaged or weak signals;
means for converting electrical signals back to fiber optical signals; and
a hybrid cable for transferring both electrical power and optical signals via the second ARP and the at least one pin penetrator on the topside of the wellhead.

16. A system according to claim 15, wherein the first ARP housing has a defined size with its largest diameter less than the inner diameter of the casing, the inner diameter of the ARP is less than a tubing diameter and connecting sides of the ARP is less than a free space between the tubing and casing, and the length of the ARP is less than a tubing length.

17. A system according to claim 15, wherein the first ARP housing is made of one or more sensor houses placed around the tubing between the tubing and casing.

18. A system according to claim 15, further comprising a data storage for storing all data from a survey or parts of data from a survey.

19. A system according to claim 15, wherein the first ARP includes thermal isolation between a tubing and the ARP housing for reducing and controlling temperature in the ARP housing.

20. A system according to claim 15, wherein the second ARP housing includes a ROV connector for transferring signals.

21. A system according to claim 15, wherein the second ARP housing includes a direct connection to a cable connected to a vessel.
